(19) United States
(12) Patent Application Publication
(10) Pub. No.: US 2022/0026782 A1
(43) Pub. Date: Jan. 27, 2022

(54) DEVICE FOR SUPPORTING A SMARTPHONE OR ACTION VIDEO CAMERA

(71) Applicants: Tim Goldburt, Elmsford, NY (US); Matt Sandy, Elmsford, NY (US)

(72) Inventors: Tim Goldburt, Elmsford, NY (US); Matt Sandy, Elmsford, NY (US)

(21) Appl. No.: 16/939,724

(22) Filed: Jul. 27, 2020

(51) Int. Cl. G03B 17/56; F16M 11/12; F16M 13/00; H04B 1/3888; H04B 1/3877

(52) U.S. Cl. CPC G03B 17/561; G03B 17/563; G03B 17/566; H04B 1/3877; F16M 13/00; H04B 1/3888; F16M 11/123

(57) ABSTRACT

A device for supporting a smartphone having a video camera or supporting an action video camera has a grip configured for supporting the smartphone having the video camera in it or supporting the action video camera, a holder configured to be controlled by a user, and components for receiving audio signals from an audio signal source and reproducing the received audio signals in the vicinity of the holder so that the video recorded by the camera includes the received audio signals.

### BACKGROUND OF THE INVENTION

The present invention relates to devices for supporting a target object, in particular a smartphone having a video camera in it and adjusting its position, for example the orientation, panning movement, rolling movement and pitching movement, to achieve a stable and smooth shooting at multiple angles; or for supporting a video camera such as an action camera and adjusting its position, for example the orientation, panning movement, rolling movement and pitching movement, to achieve a stable and smooth shooting at multiple angles.

There are various current supporting devices of this type—gimbals, stabilizers, telepods, tripods, self-recording sticks, etc. Gimbals and stabilizers for smartphones or action cameras are designed to function so that when they support a smartphone with a video camera or when they support an action video camera they provide smooth video shooting and various methods of video recording, including, but not limited to, motion time lapse, stable vertical video shooting for a social media vertical video format, and added software app functions such as facial and object tracking. However, current video camera support devices, such as gimbals, stabilizers and cameras with built-in gimbals, do not have any capability for receiving in the devices audio signals from an outside audio source and reproducing the audio signals in the vicinity of the device and therefore in the vicinity of a supported smartphone with a video camera or an action video camera during recording by a smartphone video camera or an action video camera.

### SUMMARY OF THE INVENTION

Accordingly it is an object of the present invention to provide a supporting device for supporting a target object, in particular for supporting a smartphone having a video camera or for supporting an action video camera, and adjusting its position to achieve a stable and smooth shooting, which avoids the disadvantages of the prior art devices by allowing a user to record a finished video with an accompanying audio received from an outside source and played back from the device itself in real time during video recording, in order to save the user time so that the user does not need to later spend time to post-edit the video in order to add an accompanying audio track to it.

In the present invention the device has means provided for receiving audio signals from an outside audio signal source and reproducing the received audio signals in the holder during video recording by the camera. The user can therefore simultaneously perform a video recording with the supported smartphone having a video camera or action video camera along with the audio signals received from an outside source directly in the device simultaneously, in order to create a completed video recording with the audio, so that the user does not have to later perform post editing or post production to combine the audio with the video. The user can therefore match the audio and the video recording together in real time to perfectly combine the accompanying audio to the video scene. The audio signals which are received from the outside audio sources in the present invention can be radio signals which are received from outside radio sources. Additionally, they could be from a prerecorded audio track. The video recording and the receiving of the audio signals can be activated and actuated together at the same time using a control interface for both audio and video controls, and therefore the video recorded by the camera includes the received audio signals, thus providing for new and highly advantageous results.

In keeping with these objectives and with others which will become apparent hereinafter, one feature of the present invention resides, briefly stated in a device for supporting a smartphone having a video camera in it or for supporting an action video camera, which has a grip configured for securing and gripping the smartphone with a camera or for supporting an action camera, a holder that is connected to the grip and can be configured to be held and controlled by the user, and means for receiving audio signals from an audio signal source and reproducing the received audio signals in the vicinity of the holder.

When the device for supporting a smartphone having a video camera or an action video camera is designed in accordance with the present invention, it not only supports the target object, in particular the smartphone having a video camera in it or an action video camera, and adjusts its position to achieve a stable and smooth shooting, but at the same time it allows to receive audio signals from audio sources and to reproduce them in the vicinity of the holder and also in the vicinity of the supported smartphone having a video camera or action video camera during video recording so that the video recording of the smartphone video camera or of the action video camera includes the reproduced audio signals from the device.

According to a further feature of the present invention the device for supporting a smartphone having a video camera or an action video camera of the invention further has at least two motors arranged between the holder and the grip and operating to move the grip and thereby the smartphone having a video camera, or to move the action video camera supported by the grip relative to the holder, for stabilizing the position of the smartphone, or the position of the action camera, for a stable and smooth movement recording at multiple angles. The movement of the grip and the operation of the motors can be powered up with a power control separately and independently from powering up the audio reproducing means.

According to a further feature of the present invention the device for supporting a smartphone having a video camera in it or for supporting an action video camera of the invention further has means for selecting an outside audio signal source for receiving the audio signals from the selected outside audio signal source and reproducing the received audio signal in the vicinity of the holder, which can be powered up separately by the user with the volume control means.

A further feature of the present invention resides in the device for supporting a smartphone with a video camera or an action camera, in which the user can power up or down the audio signals reproduced in the speaker with the volume control buttons. The audio signal powering up or down with the volume control buttons is separate from the powering up or down of the video control and of the movement of the grip. This allows to conserve the power management of the device and to also separately engage and start the reproduced audio signals so that the user can first search for the perfect music or audio signals in order to match the environment and scene the user is in for live video recording. For the supporting device that includes a gimbal function and motors, the user can separately power on the gimbal function and motors to engage the video recording control means in order to capture the video recorded with the supported smartphone having a video camera in it or with the action video camera by the device with the receiving audio signals. The user can therefore match the audio reproduced by the device and the video recording of the smartphone video camera or the action video camera supported by the device together in real time to perfectly combine the accompanying audio to the live video scene.

This action of combining the reproduced audio from the device with the video recording of the supported smartphone with the video camera or of the action camera can also be activated and actuated at the same time. This is done by starting the recording by the smartphone video camera with the video recording button on the device at the same time as the user powers up the volume of the reproduced audio signals with the volume control buttons or speaker volume knob. Then the video recording can be stopped at the same time with the reproduced audio signals using the audio and video controls which are all positioned on the device in the combined user interface for ease of use. This way the user's finished video recording combines and includes both the video recorded by the user and the audio selected by the user and reproduced by the device so that the user does not require post-editing of the audio in the video recorded. The advantage of this construction and its corresponding operation is that the post editing time is no longer needed by the user.

A further feature of the present invention resides in that in the device for supporting a smartphone with a video camera or an action video camera the user can activate and power up first and then adjust with a speaker control knob the volume of the speaker reproducing the audio signals from the device. This audio signal powering up or down with the speaker control knob is separate from the powering up or down of the video control and of the movement of the grip. In so doing, the audio signals reproduced by the speaker can be first played to match the intent of the video recording. For the supporting device that includes a gimbal function and motors, the user can separately power on the gimbal function and the motors to engage the video recording control means and activate the video recording so that the video recorded by the smartphone video camera or action video camera includes the reproduced audio signals from the device. This can also be activated within the same time by the user so that the start of the smartphone video recording can be activated with the video recording button at the same time as powering up the speaker reproducing the audio signals with the speaker control knob. The video recording can then be stopped at the same time with the reproduced audio signals by the user with the combined user interface with the audio and video controls. The user's finished video recording produced with the device combines both the video recorded by the user and the audio selected by the user and reproduced by the device in real time. The user can therefore produce a finished video recording with both the video and audio the user desires together in real time and not need any post-editing time later to add the desired audio to the video.

Still a further feature of the present invention resides in that the device for supporting a smartphone with a video camera or for supporting an action video camera further has means for adjusting the volume of the reproducing of the received audio signals from the selected outside audio signal source in the vicinity of the holder. This is accomplished with volume control buttons and/or the speaker volume control knob. For example, the user can first adjust the audio signal volume from the receiving audio signals, prior to then adjusting the outputted speaker volume of the reproducing audio signals so that the video recording receives the optimally adjusted audio signals. A good audio quality is critical for the live video recording, especially in an outdoors environment where the noise is higher and the audio signal should be clean and boosted to overcome the outside noise. With respect to volume amplification, with two sets of volume controls, the overall volume and audio quality can be outputted stronger and cleaner as opposed to one volume control method. If one volume control method can be adjusted on a hypothetical scale of 1 to 10, the audio signal may be distorted at a higher setting. With the two volume controls, the volume amplification range can be extended beyond the hypothetical scale to 11 and greater, and the audio signal itself can be preserved cleanly. The volume control buttons would be a first set of controls for the adjustment of the volume from the input, and the speaker volume control knob would control the volume amplification additionally for the user to achieve a good audio quality for the video recording. This is also especially important as well to overcome negative issues of audio signal distortion, noise, crackles, etc. that are made more prevalent if the user is limited to one set of volume control, as opposed to two sets of volume control.

A further feature of the present invention resides in that the device has a screen display for showing wavelengths of the audio signals, a knob for switching between AM radio waves and FM radio waves of the audio signals, and knobs for dialing a corresponding wavelength within an AM and FM ranges of the audio signals.

A further feature of the present invention resides in that the device can include an AM receiver, an FM receiver, an AM transmitter, an FM transmitter, and a speaker. Also, it can include an antenna for transmitting and receiving radio signals, a receiver circuitry and a transmitter circuitry both connected to a processor circuitry, and a control processor which controls the operation of these components, a microphone, a keypad, and a display.

A further feature of the present invention resides in that the device can receive audio inputs from a USB flash drive for inserting the USB flash drive with a digital mp3 music files playlist, and the device can receive alphanumeric or other inputs from a keypad interface with visual outputs through a display so that the user can load into and play with the device pre-recorded audio tracks.

A further feature of the present invention resides in that it includes a gimbal function and motors, and the holder is provided with an on/off power button for turning the operation of the gimbal and thereby the movement of the grip on or off, a joystick button for controlling the movement of the smartphone having a video camera or the action video camera, an orientation button for orienting the smartphone with the camera or orienting the action camera, a button for operating corresponding modes, and a button for video recording of the smartphone having a video camera that can be connected via bluetooth to wirelessly control the smartphone video camera recording.

A further feature of the present invention resides in that in that the holder is provided with an opening for attaching the device to a support and having an inner thread for screwing in a threaded end of the support, and the opening is provided in a part connectable with a remaining part of the holder by a threaded connection.

A further feature of the present invention resides in that the device has a part with a threaded portion provided with an outer thread and screwable into a lower part of the holder which is hollow and provided with an inner thread, and the holder has an inner opening which is exposed when the part is unscrewed and removed from a remaining part of the holder and which is exposed for inserting of a battery.

A further feature of the present invention resides in that in the device the holder is connected with remaining components of the device via a multi-part telescoping connecting unit composed of a plurality of elements which are telescopingly connectable with one another and are displaceable relative to one another, so that by extending or retracting of the telescoping connecting unit the distance of the grip from the holder can be reduced or increased. This allows for a highly advantageous result for the user extending the reach of the video recording, for example for self-video recording, as well as for allowing a wider field of view angle for the video recording.

A further feature of the present invention resides in that the device has a tilt axis motor and a roll axis motor applying correspondingly a tilting movement and a rolling movement to the grip, and a foldable arm having one end connected with the tilt axis motor and another opposite end pivotable connected with the pan axis motor so that the device can be folded to occupy a substantially small space, which can be convenient for its storage and transportation.

A further feature of the present invention resides in that in the device has a multi-part telescoping connecting unit composed of a plurality of elements which are telescopingly connectable with one another and are displaceable relative to one another and connecting the holder with the pan axis motor so that by extending or retracting of the telescoping connecting unit the distance of the grip to the holder can be reduced or increased. In addition, it can also have a foldable arm with one end connected with the tilt axis motor and another opposite end pivotable connected with the pan axis motor, so that the device can be folded to occupy a substantially small space which can be convenient for its storage and transportation, while also retaining the previously mention advantages allowing the user to extend the reach of the video recording, for example for self-video recording, as well as for allowing a wider field of view angle for the video recording.

A further feature of the present invention resides in that the holder has a substantially rectangular cross section and an additional portion provided with components which allow receiving audio signals from outside audio sources and reproducing them in the vicinity of the holder and therefore also in the vicinity of a supported smartphone with a video camera or of a supported action video camera during recording by the camera so that the video recording of the smartphone video camera or of the action video camera includes the reproduced audio signals from the device.

A further feature of the present invention resides in that in the device the holder includes a housing which has an additional portion provided with components which allow receiving audio signals from outside audio sources and reproducing them in the vicinity of the holder and therefore in the vicinity of a supported smartphone with video camera or of a supported action video camera during recording by the camera so that the video recording of the smartphone video camera or of the action video camera includes the reproduced audio signals from the device. The housing is supported on a tripod with adjustable legs and connected with the housing via a ball joint and fixed by a screw in its desired position. The device can further support a gimbal on its tripod with adjustable legs, by connecting the gimbal with an insert thread in its base to the housing via a ball joint and fixed by a screw in its desired position.

A further feature of the present invention resides in that in the device the holder has an on/off power button for turning the operation of the gimbal on or off, a joystick button for controlling a video recording and movement of the smartphone video camera or the action video camera, an orientation button for orienting the smartphone or the action camera, a button for operating corresponding modes, and a button for video recording that can be connected via bluetooth to wirelessly control the smartphone video camera recording, and the holder is connected with a telescoping extension support that can be controlled by a user and is composed of interconnected components that are movable toward one another and away from one another to reduce or to increase the length of the support, for convenience of the user's operation with the smartphone with a video camera or with an action video camera received in the grip.

A further feature of the present invention resides in that in the device the holder is telescoping and has a plurality of individual portions telescopingly connected with each other to increase or reduce the length of the holder, with an individual portion that is the closest to the grip having an element which is turnably connected with an element supporting the grip.

A further feature of the present invention resides in that the device has a video camera with a lens objective and a viewfinder display, and the holder is formed as a casing with a portion provided with the components which allow receiving audio signals from outside audio sources and reproducing them in the vicinity of the device during video recording by the supported camera so that the video recording of the video camera includes the reproduced audio signals from the device.

A further feature of the present invention resides in that the holder has a portion provided with components which allow receiving audio signals from outside audio sources and reproducing them in the vicinity of the device and designed for supporting of the camera which is a large camera.

A further feature of the present invention resides in that the device is formed as a pocket-size device with a casing which forms the holder, a viewfinder with a touch screen and a lens objective, a roll axis motor, a tilt axis motor, and a pan axis motor for imparting corresponding movements to an objective lens of the camera, and the casing has a portion provided with the components which allow receiving audio signals from outside audio sources and reproducing them in the vicinity of the device so that the video recording of the camera includes the reproduced audio signals from the device, and a lower portion with a thread for connecting to a support.

The novel features of the present invention are set forth in particular in the appended claims. The invention itself however will be best understood from the following description of the preferred embodiments, which is accompanied by the following drawings.

### BRIEF DESCRIPTION OF THE DRAWINGS

FIG. 1 is a view showing a known device for supporting a smartphone having a camera or an action camera; and

FIG. 1a-16 are views showing details and different embodiments of the device for supporting a smartphone having a camera or an action camera according to the present invention.

### DESCRIPTION OF THE PREFERRED EMBODIMENTS

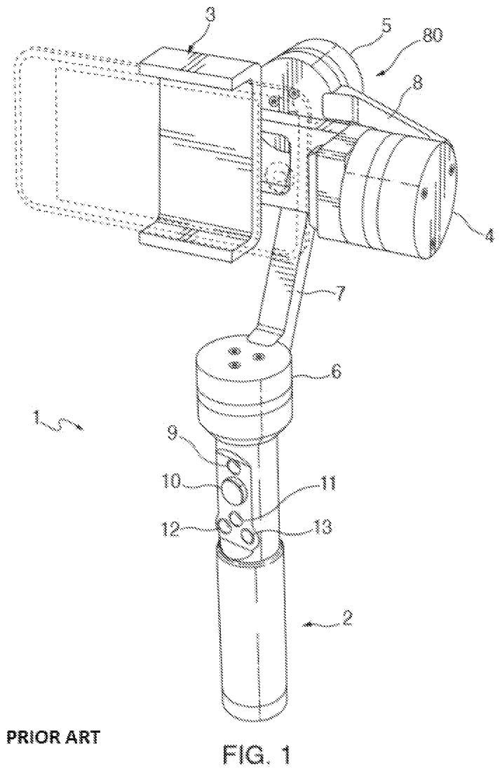

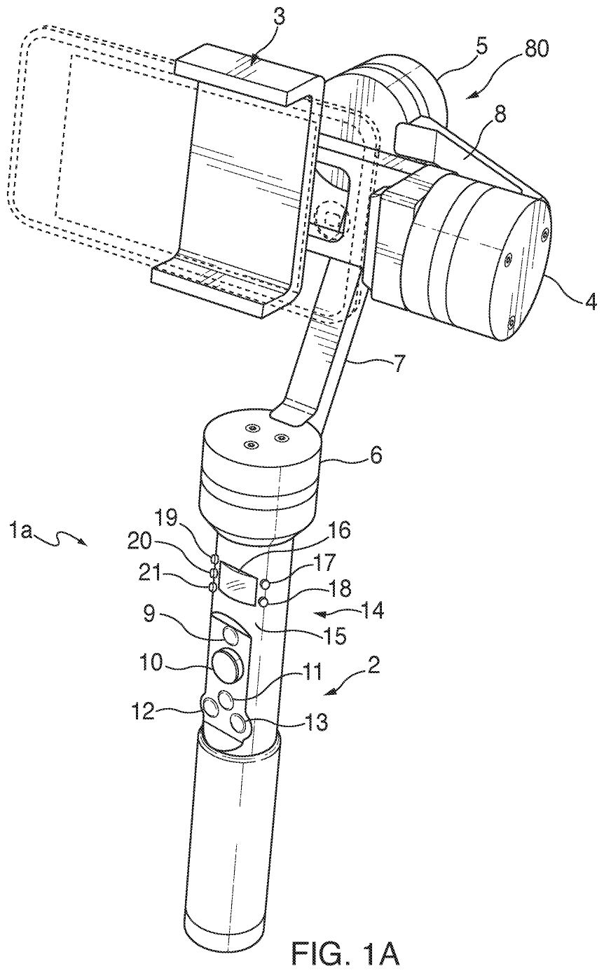

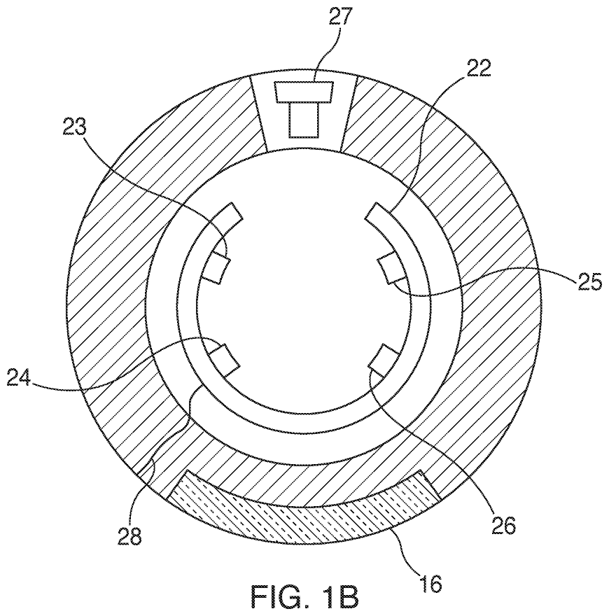

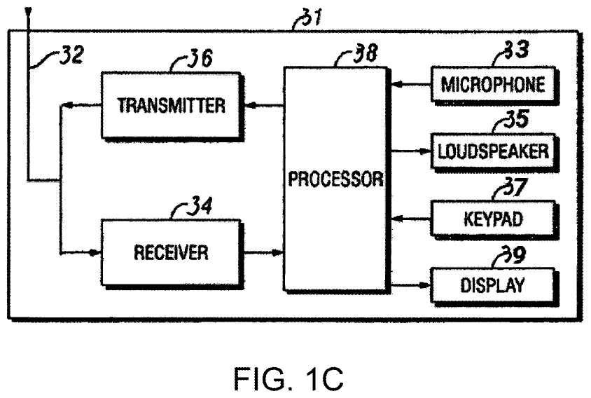

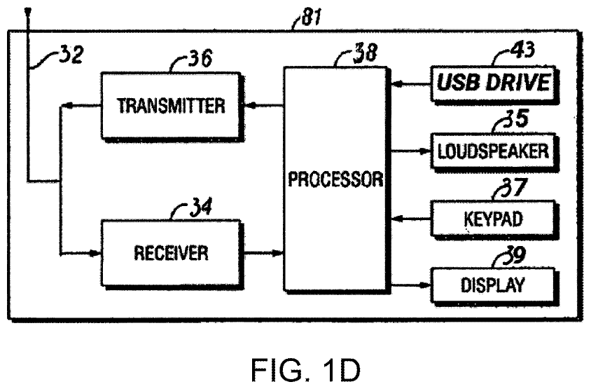

FIG. 1 of the drawings shows a perspective view of a known mobile gimbal device 1 for supporting a smartphone having a video camera or an action video camera. The gimbal device 1 has a holder 2 adapted to be held by a user and connected with a grip 3 for securing and gripping a not shown smartphone with a video camera or gripping an action video camera. It further has a gimbal 80 with a tilt axis motor 4, a roll axis motor 5, and a pan axis motor 6 for imparting corresponding movements to the grip 3 and thereby to a smartphone with a video camera or an action video camera held in the holder 3. Arms 7 and 8 connect the corresponding motors of the gimbal with one another.

The holder 2 is provided with an on/off power button 9 for turning the operation of the motors 4, 5, and 6 as well as the video recording controls on or off of the device, a joystick button 10 for controlling a video recording and the movement of the video camera of the smartphone or the action video camera, an orientation button 11 for orienting the smartphone with the video camera or the action video camera, a button 12 for operating corresponding modes, and a button 13 for video camera activation and recording.

FIG. 1A shows a gimbal device 1a designed in accordance with the present invention. It corresponds to the known device in that it can be provided with some or all above described components of device 1. The device according to the invention further has novel components and operates in a novel manner, which will now be described in detail.

In the gimbal device 1a for supporting a smartphone having a camera that provides for recording video or supporting an action video camera that provides for recording video, the holder 2 has an additional portion which is identified with reference numeral 14. This portion is provided with components 15 allowing to receive in the device 1a audio signals from an outside audio source, in order to reproduce these audio signals in the vicinity of the holder and grip of the device 1a so that therefore during video recording with the supported smartphone video camera or the action video camera, the video recording can include the reproduced audio signals from the device in real time.

The gimbal device 1a has a screen display 16 for showing wavelengths of the radio audio signals. The gimbal device 1a has an audio signal powering up and a volume adjustment up button 17 and an audio signal powering down and a volume adjusting down button 18 for adjusting the volume of received audio signals up or down correspondingly and for powering on or off the audio signals reproduced in the speaker. The gimbal device 1a has a knob 19 for switching between AM radio waves and FM radio waves, and a knob 20 for dialing a corresponding wavelength within the AM and FM ranges. The gimbal device 1a also includes an additional component knob 21 that powers up or powers down the power of the speaker that reproduces the corresponding audio signals and adjusts up or adjusts down the volume of the speaker which reproduces the corresponding audio signals.

FIG. 1B shows a cross section of the holder 2 in the area 14 accommodating the means 15. This area of the holder contains a flexible PCB 22, an AM receiver 23, an FM receiver 24, an AM transmitter 25, an FM transmitter 26, and a speaker 27. Corresponding lead wires are identified with reference numerals 28. A user of the gimbal device 1a in correspondence with this embodiment of the present invention, in addition to supporting a smartphone with a video camera or supporting an action video camera and adjusting their orientation and providing smooth stable movement video recording, can operate the above identified elements of the means 15 so as to receive the audio signals from the signal source via the receivers 23 and 24, transmit the received audio signals via the transmitters 25 and 26, and optimally reproduce in the vicinity of smartphone having a video camera or action video camera supported by the gimbal device 1a the audio signals via the speaker 27 positioned in the holder 2 below the grip 3.

FIG. 1C of the drawings shows a schematic block diagram of the device in accordance with the present invention. The device is identified as a whole with reference numeral 31 and has an antenna 32 which is used for transmitting and receiving radio audio signals. The received signals are passed to a receiver circuitry 34, while the transmitted signals are sent to the antenna 32 from a transmitter circuitry 36. The receiver circuitry 34 and the transmitter circuitry 36 are both connected to a processor circuitry 38 which, in this case, is used to represent both a signal processing circuitry and a control processor which controls the operation of the device. The processor circuitry 38 can receive audio inputs from a microphone 33, and alphanumeric or other inputs from a keypad 37, and provide audio outputs through a loudspeaker 35 and visual outputs through a display 39.

FIG. 1D of the drawings shows a schematic block diagram of the device for supporting a smartphone having a video camera or supporting an action video camera in accordance with another aspect of the present invention. In particular it shows a portable communication apparatus in which the present invention can be applied. The device is identified as a whole with reference numeral 81 and has an antenna 32 which is used for transmitting and receiving audio signals. The received signals are passed to a receiver circuitry 34, while the transmitted signals are sent to the antenna 32 from a transmitter circuitry 36. The receiver circuitry 34 and the transmitter circuitry 36 are both connected to a processor circuitry 38 which, in this case, is used to represent both a signal processing circuitry and a control processor which controls the operation of the device. The processor circuitry 38 can receive audio inputs from a USB flash drive 43 for inserting a USB flash drive with a digital mp3 music files playlist, and alphanumeric or other inputs from a keypad 37, and provide audio outputs through a loudspeaker 35 and visual outputs through a display 39.

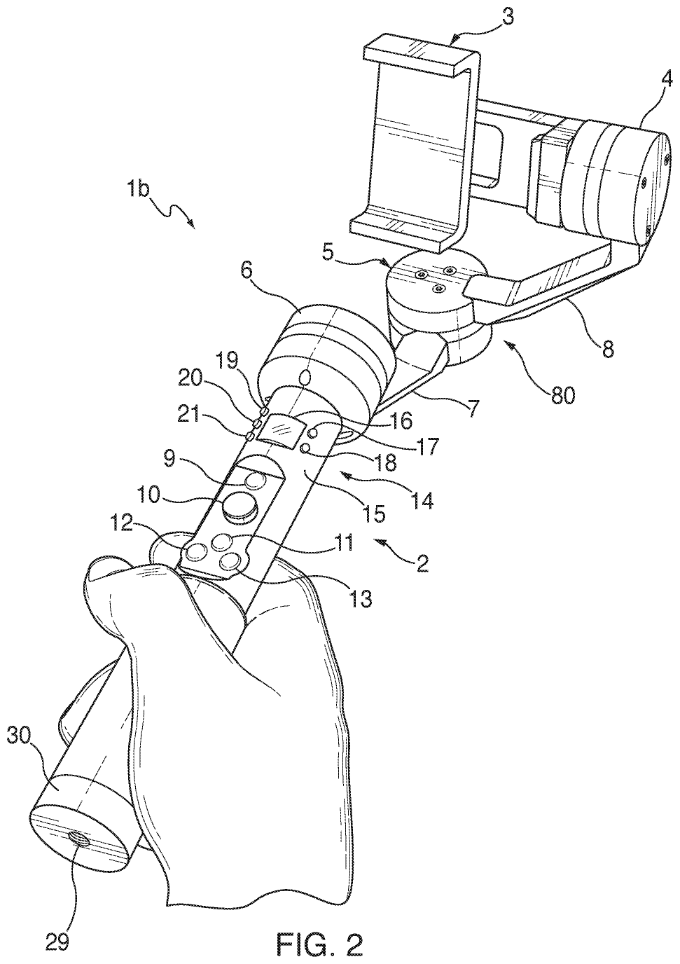

FIG. 2 of the drawings shows the gimbal device for supporting a smartphone having a video camera or supporting a action video camera in accordance with further features of the present invention. It includes the components shown in FIGS. 1A and 1B and at the same time it has additional novel features. In the device shown in FIG. 2 the holder 2 in its end which is opposite to the grip 3 is provided with an opening 29 for attaching the device to a not shown support, such as a monopod, a tripod or the like. The opening 29 can be provided with an inner thread for screwing in a corresponding threaded end of such a support. The opening 29 can be provided in a part 30 connectable with a remaining part of the holder 2, for example also by a threaded connection.

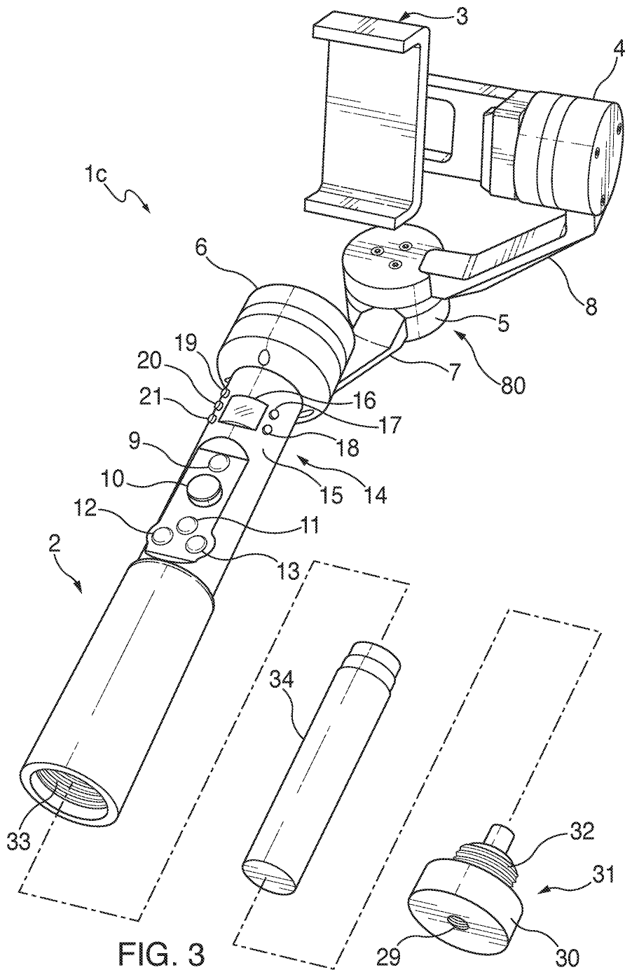

FIG. 3 of the drawings shows the device for supporting a smartphone with a video camera or supporting an action video camera in accordance with further features of the present invention. It includes the components shown in FIGS. 1A, 1B and 2 and at the same time it has additional novel features. In the device shown in FIG. 3 the part 30 which has a threaded portion 31 is provided with an outer thread 32. It can be screwed into the lower part of the holder 2 which is hollow and provided with an inner thread 33. When the part 30 is unscrewed and removed from a remaining part of the holder 2, an inner opening in the holder is exposed and a replaceable battery 34 can be inserted into the hollow holder, with the subsequent threaded connection of the part 30 to the remaining part of the holder 2 to close the inner opening. While FIG. 3 shows that the device for supporting a smartphone with a video camera or supporting an action video camera of the invention is battery operated, and possibly with a rechargeable battery, the device can be designed so that it can be rechargeable from an outside current source without any need from a battery.

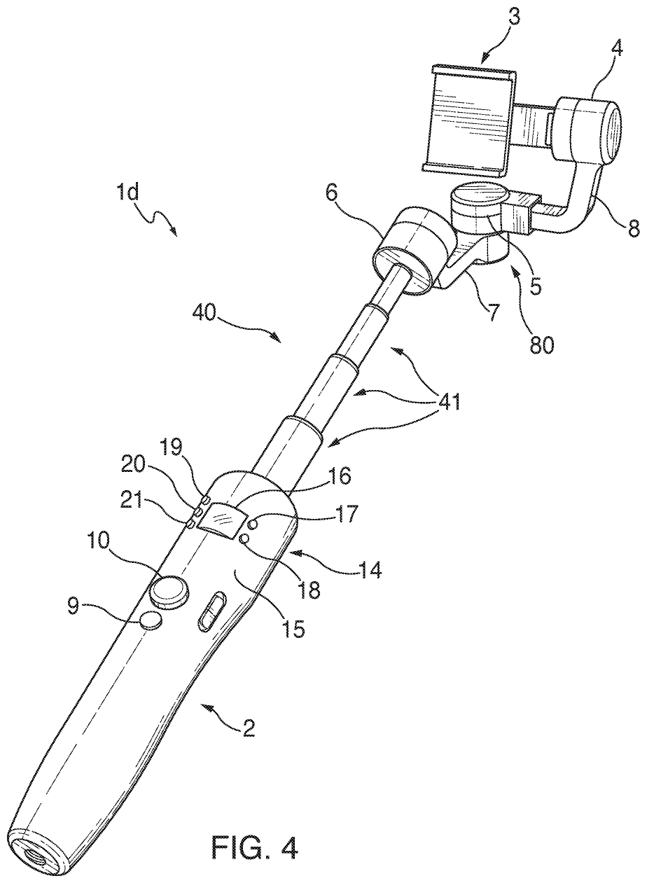

FIG. 4 of the drawings shows the device for supporting a smartphone having a video camera or supporting an action video camera in accordance with a further feature of the present invention. It includes the components shown in FIGS. 1A and 1B and at the same time it has additional novel features. In the device shown in FIG. 4 the holder 2 is connected with remaining components of the device via a multi-part telescoping connecting unit 40 composed of a plurality of elements 41 which are telescopingly connectable with one another and are displaceable relative to one another. More particularly, while one end of the telescoping connecting unit 40 is connected with the holder 2, its opposite end is connected with the pan axis motor 6. As a result, by extending or retracting of the telescoping connecting unit 40 the distance of the grip 3 gripping a not shown smartphone with a video camera or with an action video camera from the holder 2 can be reduced or increased depending on a user's preference.

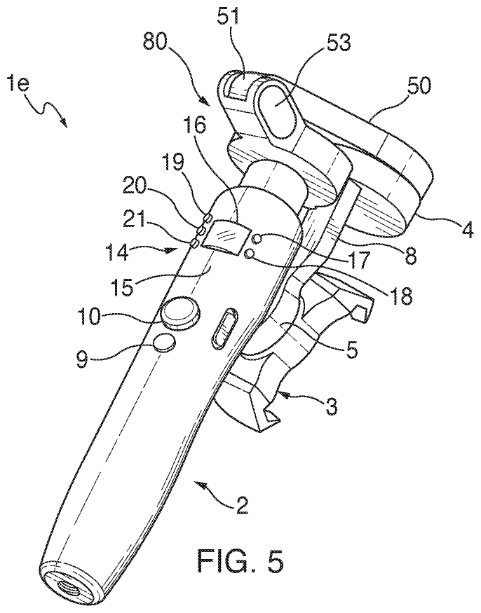

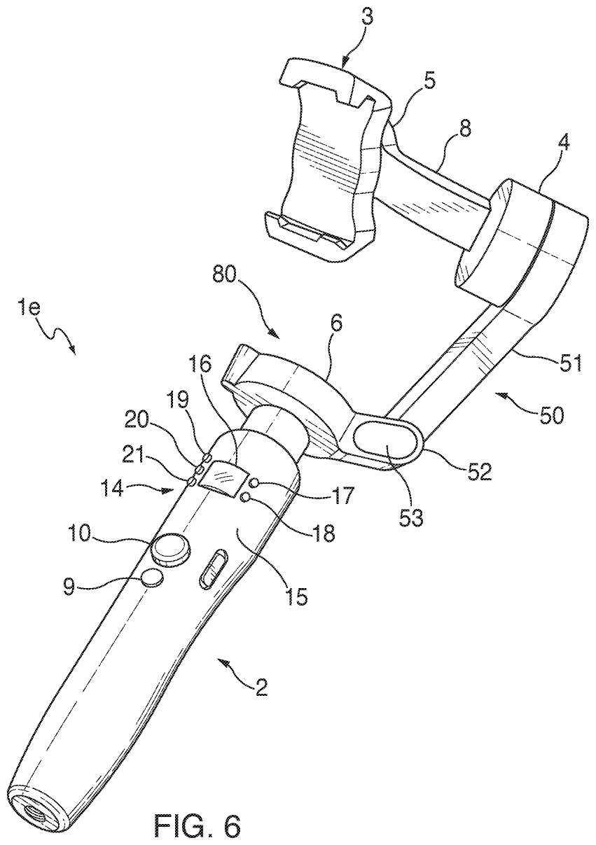

FIGS. 5 and 6 of the drawings show the device for supporting a smartphone having a video camera or supporting an action video camera in accordance with a further feature of the present invention. It includes the components shown in FIGS. 1A and 1B and at the same time has additional novel features. In the gimbal device shown in FIGS. 5 and 6 a foldable arm 50 is provided. The foldable arm 50 has one end 51 connected with the tilt axis motor 4 and another opposite end 52 which is pivotable and connected with the pan axis motor 5, with covers 53 covering opposite axial ends of the pivotal connection. As shown in this figure, the device can be folded so as to occupy a substantially small space, which can be convenient for its storage and transportation.

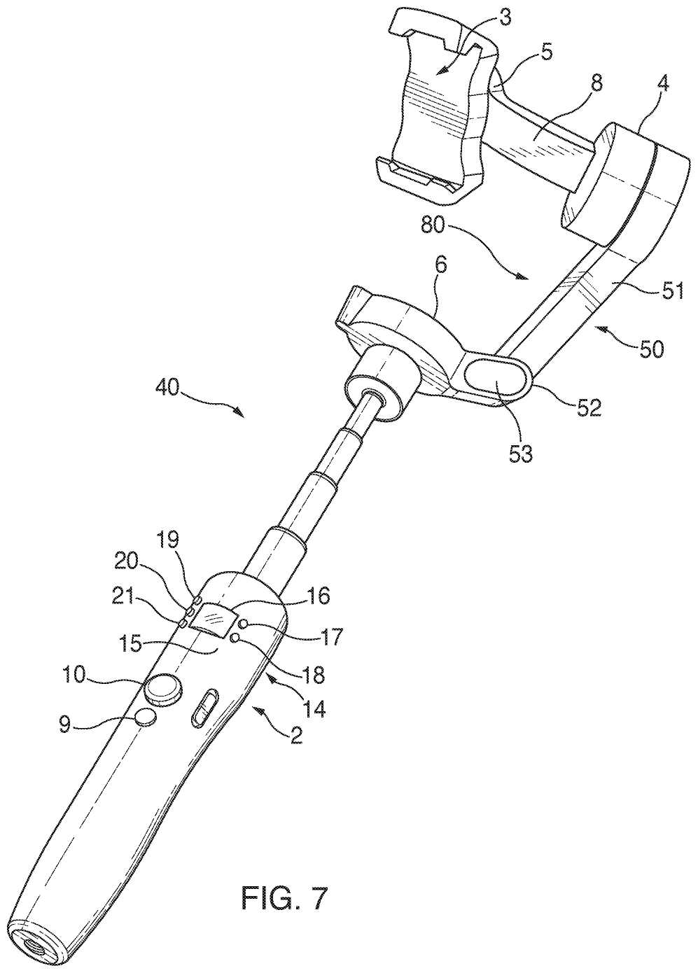

FIG. 7 of the drawings shows a gimbal device for supporting a smartphone having a video camera or supporting an action video camera in accordance with a further feature of the present invention. The supporting device 1f has a holder 2 adapted to be held by a user and connected with a grip 3 for securing and gripping a not shown smartphone with a video camera or holding an action video camera. It further has a gimbal with a tilt axis motor 4, a roll axis motor 5, and a pan axis motor 6 for imparting corresponding movements to the grip 3 and thereby to a smartphone with the video camera or to an action video camera held in the grip 3. A multi-part telescoping connecting unit 40 is provided and composed of a plurality of elements 41 that are telescopingly connectable with one another and are displaceable relative to one another. This telescoping connecting unit 40 connects the holder 2 with the pan axis motor 6. As a result, by extending or retracting the telescoping connecting unit 40 the distance of the grip 3, and thereby of a not shown smartphone with a video camera or of an action video camera secured in the grip 3, can be reduced or increased depending on a user's preference. A foldable arm 50 is further provided and has one end 51 connected with the tilt axis motor 4 and another opposite end 52 which is pivotable connected with the pan axis motor 6, with covers 53 covering opposite axial ends of the pivotal connection. As a result, the device can be folded so as to occupy a substantially small space, which can be convenient for its storage and transportation.

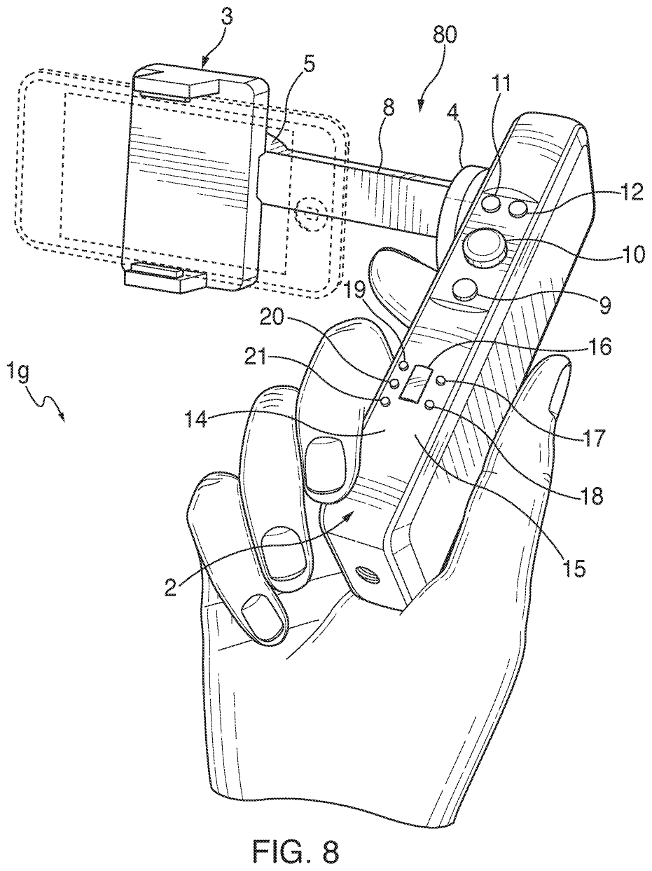

FIG. 8 of the drawings shows the device for supporting a smartphone having a video camera or supporting an action video camera in accordance with a further feature of the present invention. The supporting device 1g has a holder 2 adapted to be held by a user and connected with a grip 3 for securing and holding a not shown smartphone with a video camera or an action video camera. It further has a roll axis motor 5 and a tilt axis motor 4 for imparting corresponding movements to the grip 3 and thereby to a smartphone with the video camera or to an action video camera held in the grip 3. The holder 2 in the embodiment has a substantially rectangular cross section. Similarly to the embodiment of FIGS. 1A and 1B, it has an additional portion which is identified with reference numeral 14 and provided with components 15 which allow receiving audio signals from outside audio sources and reproducing them in the vicinity of the device and therefore in the vicinity of a supported smartphone with the video camera or of the supported action video camera during recording by the video camera so that the video recording includes the reproduced audio signals from the device.

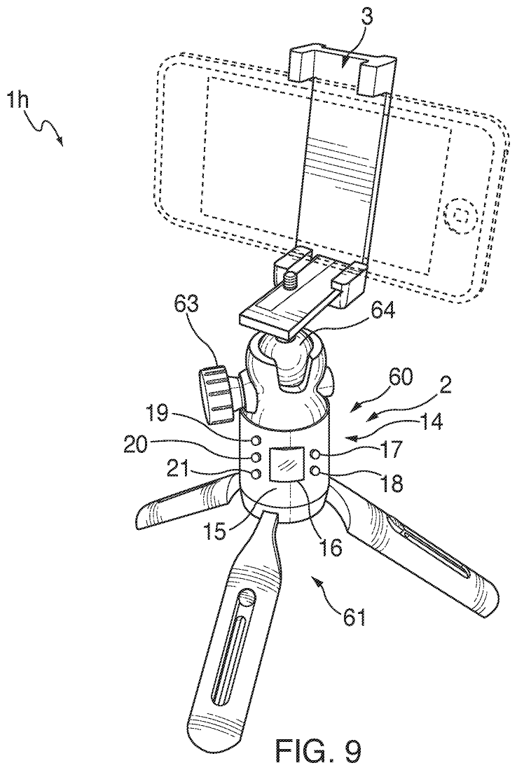

FIG. 9 of the drawings shows the device for supporting a smartphone having a camera or supporting a camera in accordance with a further feature of the present invention. The supporting device 1h is a small tripod that has a holder 2 connected with the grip 3 for gripping a not shown smartphone with a video camera or an action video camera. The device 1h includes a housing 60 that has an additional portion which is identified with reference numeral 14 and is provided with components 15 which allow receiving audio signals from outside audio sources and reproducing them in the vicinity of the holder of the device and therefore in the vicinity of the supported smartphone with a video camera or of a supported action video camera during recording by the video camera so that the video recording includes the reproduced audio signals from the device. The housing 60 is supported on a tripod 61 with adjustable legs 62 that allow to extend the height and reach of the device. The grip 3 is connected with the housing 60 via a ball joint 64 and fixed by a screw 63 in its desired position.

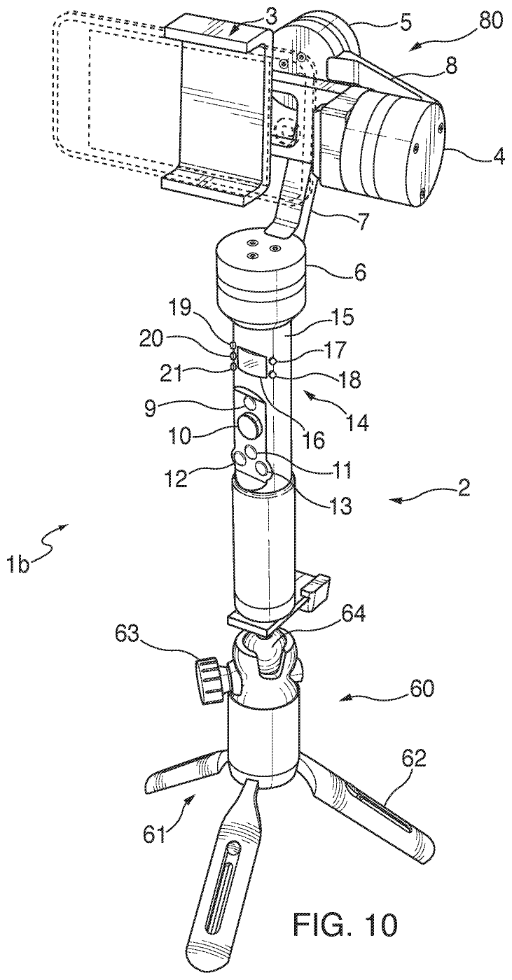

FIG. 10 of the drawings shows the device 1h of FIG. 9 for supporting a smartphone having a video camera or supporting an action video camera in accordance with a further feature of the present invention. The supporting device 1h can further support the previously shown device 1b via the insert 29. This way the gimbal device 1h can stand on a table or flat surface. Supporting device 1h has a holder 2 that is supported by the tripod 61 with adjustable legs 62. The holder 2 is connected with the housing 60 via a ball joint 64 and fixed by a screw 63 in its desired position.

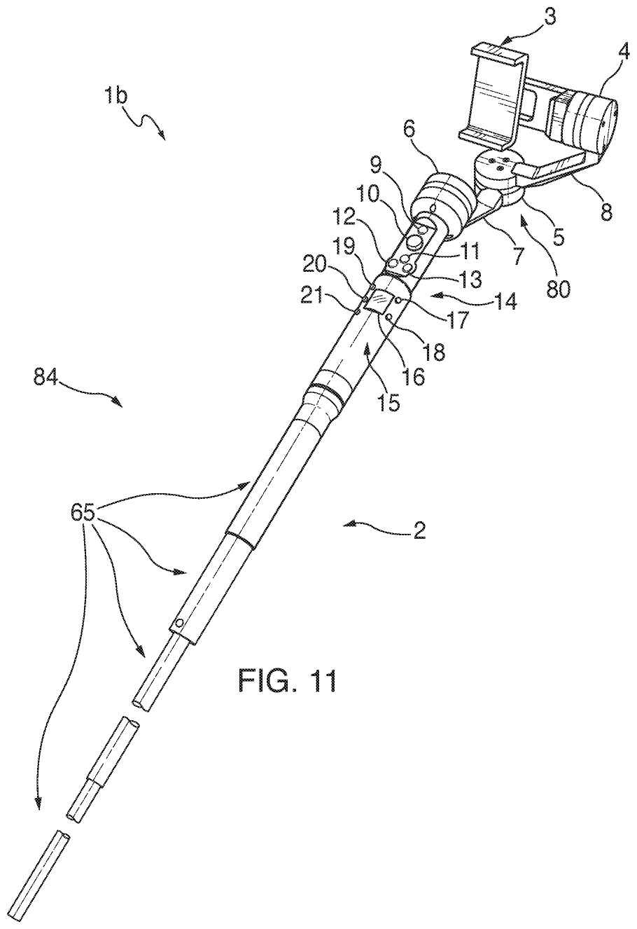

FIG. 11 of the drawings shows the device for supporting a smartphone having a video camera or supporting an action video camera in accordance with a further feature of the present invention. The supporting device 1b has a holder 2 to be held by a user and connected with the grip 3 for receiving and gripping a not shown smartphone with a video camera or receiving and holding an action video camera. The holder 2 is connected with an independent external telescoping extension support pole which can be held by a user and is composed of interconnected components 65 which are movable toward one another and away from one another to reduce or to increase the length of the support 64, for convenience of user's operation with the smartphone having a video camera or with the action video camera received in the grip 3. The extension support is inserted at the base of the supporting device 1b via the insert 29.

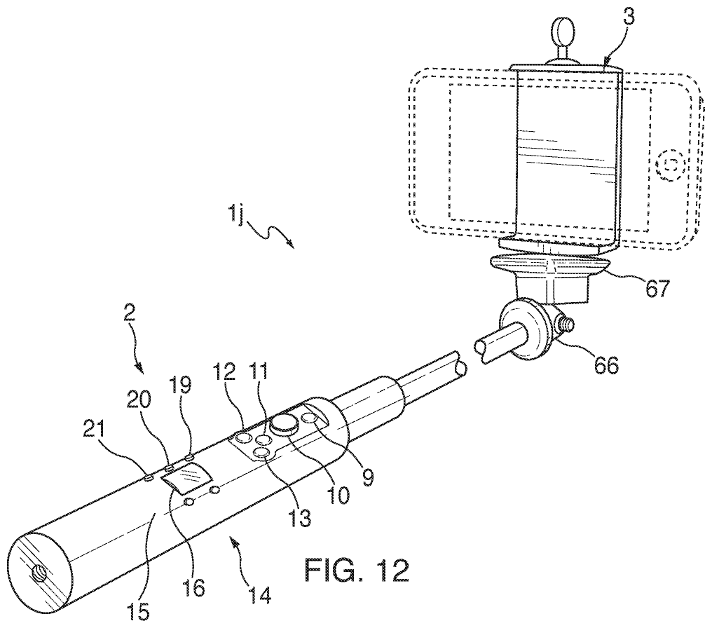

FIG. 12 of the drawings shows the device for supporting a smartphone having a video camera or supporting an action video camera in accordance with a further feature of the present invention. The supporting device 1j is a selfie stick that has a holder 2 adapted to be held by a user and connected with a grip 3 for receiving and gripping a not shown smartphone with a camera or an action camera. The supporting device holder 2, similarly to the device of FIG. 1A, has an additional portion which is identified with reference numeral 14. This portion is provided with the components 15 allowing to receive audio signals from audio sources and reproducing them in the vicinity of the holder of the device and therefore in the vicinity of a supported smartphone with a camera or a supported camera during recording by the camera so that the video recording of the camera includes the reproduced audio signals from the device. The holder 2 in this embodiment is telescoping and has a plurality of individual portions telescopingly connected with each other to increase or reduce the length of the holder 2. The individual portion which is the closest to the grip 3 has an element 66 which is turnably connected with an element 67 supporting the grip 3.

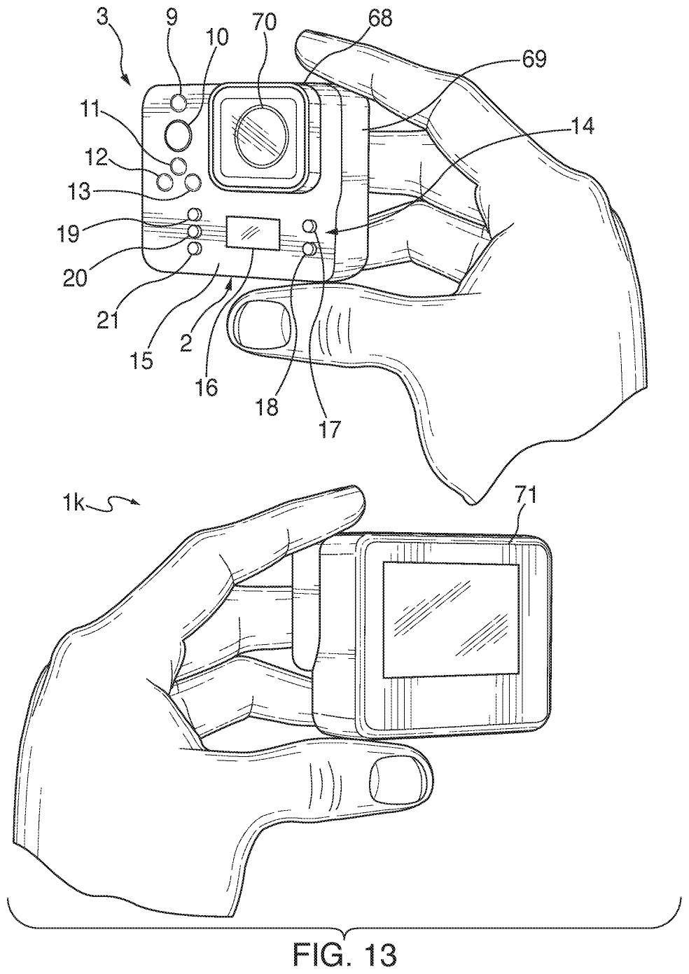

FIG. 13 of the drawings shows the device for supporting an action video camera 68 in accordance with a further feature of the present invention. The supporting device in this embodiment has a holder 2 formed as a casing 69 of the camera 68, which is shown from its front side on the right view and from its rear side on the left view. The camera 68 has a camera casing forming a grip 3, an objective 70 and a viewfinder display 71. The casing 69 of the camera 68 has a portion which is identified with reference numeral 14 and provided with the components 15 allowing receiving audio signals from outside audio sources and reproducing them in the vicinity of the holder of the device and thereby in the vicinity of the supported video camera during recording by the supported video camera so that the video recording of the camera includes the reproduced audio signals from the device, as in the embodiments of FIG. 1A.

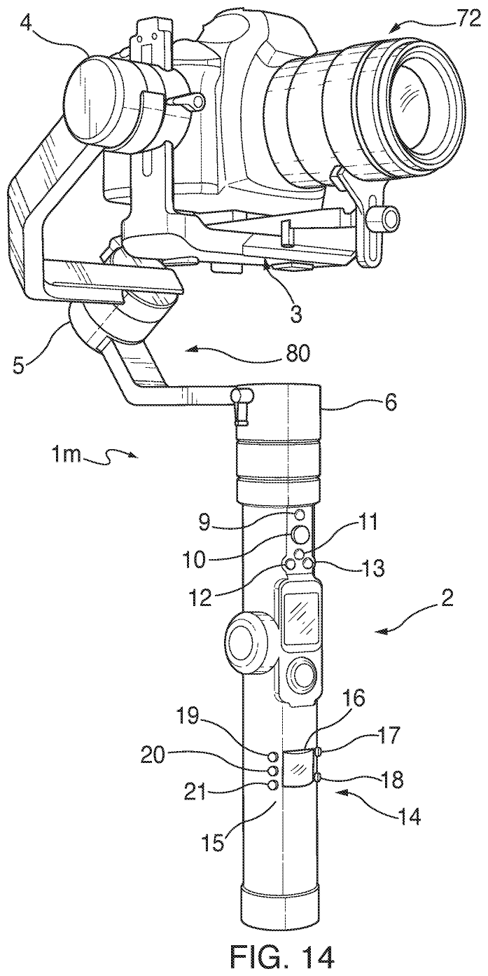

FIG. 14 shows the device for supporting a large video camera 72 in accordance with a further feature of the present invention which is held in the grip 3. This device has components corresponding to the components of the device shown in FIG. 1A. In particular it has the three motors 4, 5, 6 and the grip 3. It also has the holder 2 with an additional portion which is identified with reference numeral 14 and provided with the same components 15 which allow receiving audio signals from outside audio sources and reproducing them in the vicinity of the device and in the vicinity of the supported large video camera during recording by the supported large video camera, so that the video recording of the large video camera includes the reproduced audio signals from the device.

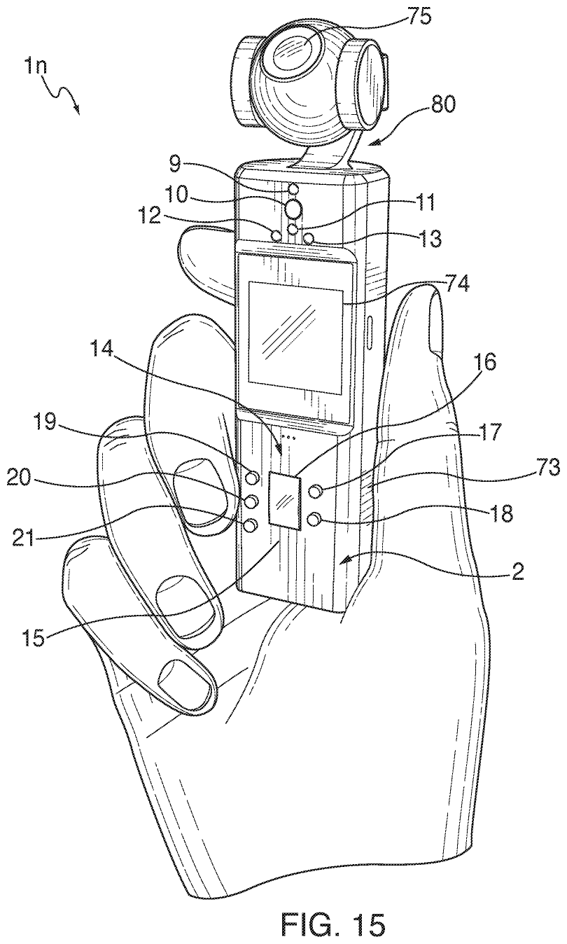

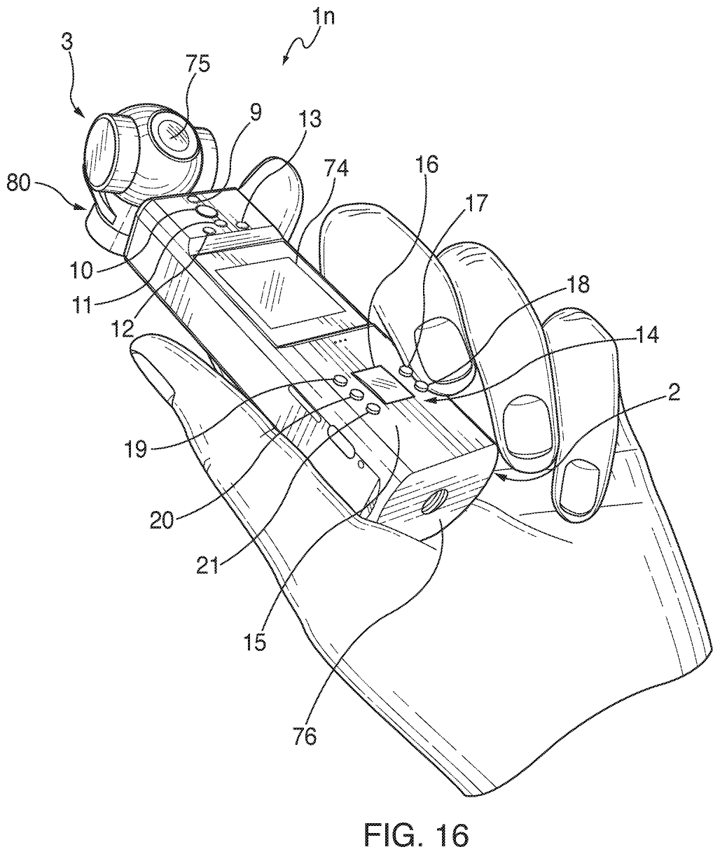

FIGS. 15 and 16 show a pocket-sized device for supporting a video camera in accordance with a further feature of the present invention. The device has a casing 73 with a portion which corresponds to the holder 2 and another portion which corresponds to the grip 3. A viewfinder with a touch screen is identified with reference numeral 74 and a camera lens objective is identified with reference numeral 75. The device further has a roll axis motor 5, a tilt axis motor 4, and a pan axis motor 6 for imparting corresponding movements to the camera lens objective 75 of the video camera. The supporting device has further components corresponding to the components of the device shown in FIG. 1A. In particular the casing 73 of the device has a portion which is identified with reference numeral 14 and provided with the same components 15 which allow receiving audio signals from outside audio sources and reproducing them in the vicinity of the holder 2 during video recording by the supported video camera, so that the video recording of the camera includes the reproduced audio signals from the device. The holder 2 of the device further has a lower portion with a thread 76 for connecting to a support, such as a monopod, a tripod or the like.

The present invention is not limited to the details shown since various modification and structural changes are possible without departing from the spirit of the invention.

What is desired to be protected by Letters Patent is set forth in particular in the appended claims:

1. A device for supporting a smartphone having a video camera for recording a video or supporting an action video camera for recording a video, comprising
a gimbal that stabilizes a video recording by the smartphone video camera or by the action video camera;
a grip connected to the gimbal and securing the smartphone having the video camera or the action video camera;
a holder connected to the gimbal and controllable by a user and also provided with a speaker;
a power button provided in the holder and operative for powering on or off the movement of the gimbal and thereby the movement of the grip;
components provided in the holder allowing to receive in the device audio signals from an outside audio source, in order to reproduce these audio signals in the vicinity of the holder and the grip of the device so that during video recording with the supported smartphone video camera or the action video camera, the video recording can include the reproduced audio signals from the device;
an audio signal powering up and a volume adjustment up button for powering on the audio signals reproduced in the speaker and for adjusting the volume of the received audio signals up, independently from powering up the movement of the gimbal and thereby the movement of the grip.

2. (canceled)

3. A device for supporting a smartphone having a video camera for recording a video or supporting an action video camera for recording a video, comprising
a gimbal that stabilizes a video recording by the smartphone video camera or by the action video camera;
a grip connected to the gimbal and securing the smartphone having the video camera or the action video camera;
a holder connected to the gimbal and controllable by a user and also provided with a speaker;
a power button provided in the holder and operative for powering on or off the movement of the gimbal and thereby the movement of the grip;
components provided in the holder allowing to receive in the device audio signals from an outside audio source, in order to reproduce these audio signals in the vicinity of the holder and the grip of the device so that during video recording with the supported smartphone video camera or the action video camera, the video recording can include the reproduced audio signals from the device; and
an audio signal powering down and a volume adjusting down button, for powering off the audio signals reproduced in the speaker and for adjusting the volume of the received audio signals down.

4. A device as defined in claim 1, further comprising video camera activation and recording means operating so that the video recording and the receiving of the audio signals are actuated at the same time.

5. A device as defined in claim 1, further comprising an antenna for receiving and transmitting audio signals which are radio signals, a receiver circuitry and a transmitter circuitry both connected to a processor circuitry, a control processor, a knob for switching radio waves of the radio signals, and a knob for dialing a corresponding wavelength within radio frequency ranges of the radio signals, and a display for showing wavelengths of the radio signals.

6. A device as defined in claim 1, wherein the gimbal includes at least two motors arranged between the holder and the grip and operative for moving the grip and thereby the smartphone with a video camera secured in the grip or the action video camera secured in the grip for stabilizing a position of the smartphone having the video camera or a position of the action video camera.

7. A device as defined in claim 3, further comprising video camera activation and recording means operating so that the video recording and the receiving of the audio signals are actuated at the same time.

8. A device as defined in claim 3, further comprising an antenna for receiving and transmitting audio signals which are radio signals, a receiver circuitry and a transmitter circuitry both connected to a processor circuitry, a control processor, a knob for switching radio waves of the radio signals, and a knob for dialing a corresponding wavelength within radio frequency ranges of the radio signals, and a display for showing wavelengths of the radio signals.

9. A device as defined in claim 3, wherein the gimbal includes at least two motors arranged between the holder and the grip and operative for moving the grip and thereby the smartphone with a video camera secured in the grip or the action video camera secured in the grip for stabilizing a position of the smartphone having the video camera or a position of the action video camera.

10. A device for supporting a smartphone having a video camera for recording a video or supporting an action video camera for recording a video, comprising
a gimbal that stabilizes a video recording by the smartphone video camera or by the action video camera;
a grip connected to the gimbal and securing the smartphone having the video camera or the action video camera;
a holder connected to the gimbal and controllable by a user and also provided with a speaker;
a power button provided in the holder and operative for powering on or off the movement of the gimbal and thereby the movement of the grip;
components provided in the holder allowing to receive in the device audio signals from an outside audio source, in order to reproduce these audio signals in the vicinity of the holder and the grip of the device so that during video recording with the supported smartphone video camera or the action video camera, the video recording includes the reproduced audio signals from the device;
an audio signal powering up and a volume adjustment up button for powering on the audio signals reproduced in the speaker and for adjusting the volume of the received audio signals up, independently from powering up the movement of the gimbal and thereby the movement of the grip; and
an audio signal powering down and a volume adjusting down button, for powering off the audio signals reproduced in the speaker and for adjusting the volume of the received audio signals down.
